(19) United States
(12) Patent Application Publication
(10) Pub. No.: US 2026/0204705 A1
(43) Pub. Date: Jul. 16, 2026

(54) THERMOPLASTIC INTENSIVE AND ENERGY DENSE STRUCTURAL BATTERY PACK FOR CUBOIDAL CELLS

(71) Applicant: SABIC GLOBAL TECHNOLOGIES B.V., Bergen op Zoom (NL)

(72) Inventors: Dinesh MUNJURULIMANA, South Lyon, MI (US); Sreekanth PANNALA, Sugar Land, TX (US)

(21) Appl. No.: 19/127,998

(22) PCT Filed: Nov. 7, 2023
(86) PCT No.: PCT/EP2023/081010

§ 371 Date: May 7, 2025

(30) Foreign Application Priority Data
Nov. 8, 2022 (EP) 22206078.2

(51) Int. Cl. H01M 50/229; H01M 10/613; H01M 10/647; H01M 10/6556; H01M 10/658; H01M 50/209; H01M 50/227; H01M 50/242; H01M 50/278; H01M 50/291; H01M 50/293

(52) U.S. Cl. CPC H01M 50/229; H01M 10/613; H01M 10/647; H01M 10/6556; H01M 10/658; H01M 50/209; H01M 50/227; H01M 50/242; H01M 50/278; H01M 50/291; H01M 50/293

(57) ABSTRACT

A battery pack enclosure comprises a cover, and a plastic-intensive structural cell holder (PISCH). The PISCH is designed to hold a plurality of cuboidal battery cells, and comprises a plastic tray and a plurality of structural cell holders. The plurality of structural cell holders extend vertically from a top side of the plastic tray, wherein the top side of the plastic tray is opposite a bottom side thereof. The plastic tray comprises a plurality of coolant channels integrated into the top side of the plastic tray and configured to contain coolant. The cover is configured to cover tops of the plurality of structural cell holders when the PISCH is in a closed configuration. The plastic of the PISCH acts as a thermal barrier and as a structural support.

### TECHNICAL FIELD

The present disclosure relates generally to battery packs. More specifically, the present disclosure relates to battery pack enclosures for enclosing a plurality of battery cells. Still more specifically, the present disclosure relates to battery pack enclosures for cuboidal battery cells.

### BACKGROUND

Herein disclosed is a battery pack enclosure comprising: a cover; and a plastic-intensive structural cell holder (PISCH) configured to hold a plurality of cuboidal battery cells, wherein the PISCH comprises a plastic tray and a plurality of structural cell holders, wherein the plurality of structural cell holders extend vertically from a top side of the plastic tray, wherein the top side of the plastic tray is opposite a bottom side thereof, and wherein the plastic tray comprises a plurality of coolant channels integrated into the top side of the plastic tray and configured to contain coolant, wherein the cover is configured to cover tops of the plurality of structural cell holders when the PISCH is in a closed configuration.

Also disclosed herein is an apparatus for housing battery cells, the apparatus comprising: the battery pack enclosure of this disclosure and a bottom impact protection system (BIPS).

Further disclosed herein is a battery pack comprising: the apparatus for housing battery cells of this disclosure in an assembled configuration in which the battery pack enclosure encloses the plurality of cuboidal cells.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic of a battery pack, according to embodiments of this disclosure;

FIG. 2 is a schematic of a plastic-intensive structural cell holder with cells assembled and connected, according to embodiments of this disclosure;

FIG. 3A is a schematic of a section of a battery pack, disassembled, according to embodiments of this disclosure;

FIG. 3B is a schematic of the section of battery pack of FIG. 3A, in an assembled configuration, according to embodiments of this disclosure;

FIG. 4 is a schematic, top view of a plastic tray, according to embodiments of this disclosure;

FIG. 5 is a close up bottom-view schematic of a section of the plastic tray of FIG. 4;

FIG. 6 is a schematic bottom view of a cover, according to embodiments of this disclosure;

FIG. 7A is a schematic bottom view of a cover, according to embodiments of this disclosure;

FIG. 7B is a close up of a portion of the schematic bottom view of the cover of FIG. 7A;

FIG. 8A shows the results of side impact testing of the comparative battery pack of the Example; and

FIG. 8B shows the results of side impact testing of an inventive battery pack of this disclosure, as per the Example.

### DETAILED DESCRIPTION

It should be understood at the outset that although an illustrative implementation of one or more embodiments are provided below, the disclosed systems and/or methods can be implemented using any number of techniques, whether currently known or in existence. The disclosure should in no way be limited to the illustrative implementations, drawings, and techniques below, including the exemplary designs and implementations illustrated and described herein, but can be modified within the scope of the appended claims along with their full scope of equivalents.

As utilized herein, the phrase “cuboidal cells” indicates battery cells having the shape of the cuboid with length (L), width (W), and height (H). Here the L, W, H can be the same as in a cube or different L≠W≠H or L=W and L≠H or combinations thereof. The cell internals can be typical Li-ion or Na-ion or other battery chemistries in the stacked or wound formats. The cell internal structure can be of conventional type or can be of the novel cell architecture detailed further hereinbelow. The cell containers can be made of steel or aluminum or aluminum laminate films or other materials.

Disclosed herein are battery pack enclosures, apparatus for housing battery cells comprising such battery pack enclosures and a bottom impact protection system, and battery packs comprising the battery pack enclosures enclosing a plurality of battery cells.

The innovative thermoplastic-intensive battery pack enclosure of this disclosure includes a plastic-intensive structural cell holder (PISCH) comprising a plastic intensive tray with integrated cell holders for novel cuboidal cells and a plastic-intensive cover with built-in barriers configured to delay cell-to-cell propagation of a thermal runaway incident from any battery cell and safeguard the electrical connections between the battery cells in the event of a thermal event. Further benefits provided by the use of the disclosed battery pack enclosure include, but are not limited to: an increase in an overall pack energy density (e.g., by 20% or more as compared to a cell-to-module and/or module-to-pack architecture) provided by the plastic-intensive structural backbone; a reduction in the number of battery cells (e.g., one-tenth the number of cells, for example, compared to 2170 cylindrical cells) and simpler connections and cooling; low internal cell resistance, uniform temperature and voltage distribution, safe discharge upon abuse, and built-in crash protection; integration of busbars/electrical connectors into the cover of the battery pack enclosure and enabling the busbars/electrical connectors to snap onto the cells to simplify the assembly process; enabling snapping of the battery cells into the receiving cellular pack enclosure to allow for easy assembly, disassembly, and also to enable recyclability of battery cells and the battery cell enclosure; and/or design of the battery pack enclosure with internal ducts to enable easy flow of product gases in case of a thermal runaway incident to prevent pressure build-up.

Volumetric efficiency, often measured as kilowatt hours (KWh) per unit volume, of most conventional battery packs containing existing battery cell technologies and battery pack enclosures and relevant accessories, such as connectors, busbars, etc., is relatively low. This can be due primarily to the fact that such conventional battery packs require space to package secondary components, such as thermal management systems, structural components, and thermal runaway mitigation systems of the battery packs, which are designed to ensure the durability of the battery pack, the functionality of battery pack during normal operations, and meeting of regulatory requirements that define performance of the battery pack in the event of a thermal event or a crash. Each of these aforementioned secondary components is designed to meet these specific requirements. Additionally, the types of cell technologies utilized in some of the conventional battery packs, are not inherently efficient in maximum utilization of available space. For example, cylindrical battery cells do not pack well, pouch cells typically require additional support structure, and prismatic cells are typically not efficient in removing internal heat. When assembled in modules and packs, these conventional cell types result in lower volumetric efficiencies, relative to the herein disclosed cuboidal battery cells.

Several of the aforementioned issues are mitigated via this disclosure by the utilization of a novel cuboidal battery cell technology that maximizes the volumetric efficiency at the cell level and by a novel battery cell enclosure, each component of which provides multiple functionality. Via this disclosure, plastics are utilized not only as a thermal barrier to mitigate runaway propagation from one battery cell to another, but also as a structural member providing stiffness and strength in the event of a mechanical intrusion.

As noted hereinabove, in a conventional battery pack comprising cylindrical cells, the space between adjacent cells is not effectively utilized. Additionally, cell holders are typically utilized on the top and bottom of such conventional battery packs to secure the cylindrical battery cells and to ensure that the electrical circuit is properly closed during operation. Furthermore, additional coolant paths are conventionally positioned between the cylindrical battery cells and at the bottom of the cylindrical battery cells of such conventional battery packs to ensure that the temperature of the cylindrical battery cells is maintained adequately during normal operation, charging and discharging. These additional systems not only make such conventional battery packs inefficient, by adding weight and volume thereto, but also result in added complexity of the assembly, thus increasing the cost for production of such conventional battery packs.

Herein disclosed is a novel thermoplastic battery enclosure that has a plastic-intensive structural backbone designed to package cuboidal battery cells. The thermoplastic hybrid system of this disclosure serves as a structural backbone to host the cuboidal battery cells, and also serves as an effective thermal management system to control the temperature of the cuboidal battery cells by effectively transferring heat to battery cells or from the battery cells as needed, as detailed further hereinbelow. The battery enclosure of this disclosure includes a plastic tray with integrated cooling channels and structural (e.g., honeycomb) rib configurations. A thermoplastic intensive lid/cover can be utilized to close the enclosure assembly. The thermoplastic intensive lid/cover provides integrated thermal barrier protection covering the electrical connections used to close the electrical circuits between the battery cells. In embodiments, the herein disclosed hybrid thermoplastic battery enclosure can be formed via common manufacturing methods, such as injection molding and or compression molding.

A thermoplastic intensive battery pack comprising the battery pack enclosure and cuboidal cells can have an increased (e.g., 20% greater or more) overall pack energy density than a typical cylindrical battery pack of the same size. The herein disclosed battery pack can provide for a simpler assembly, by reducing the number of cells (e.g., by at least 10% relative to typical cylindrical battery pack of the same size), and providing for simpler connections and/or cooling systems.

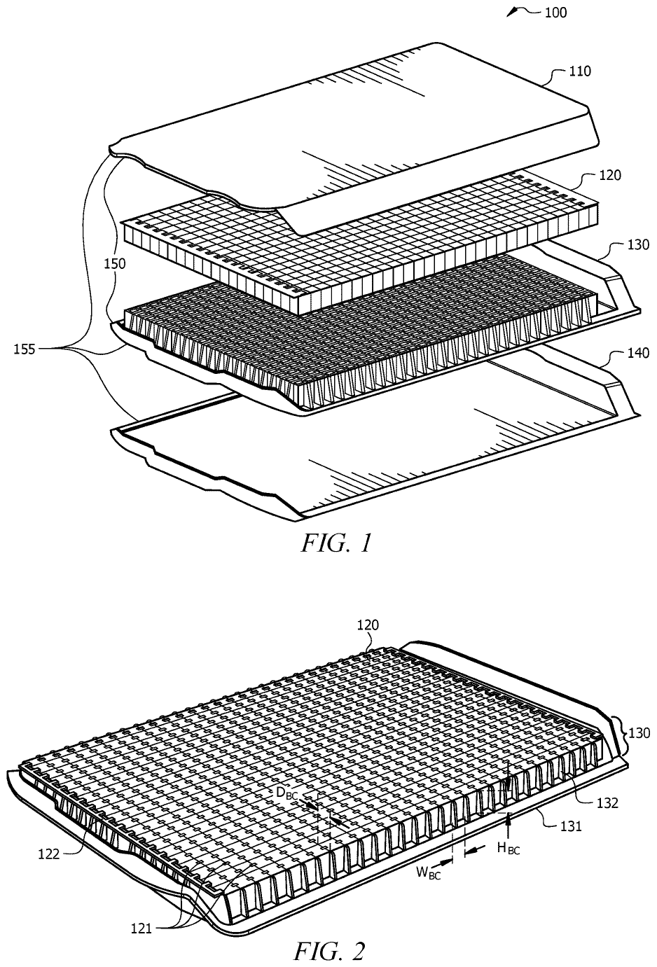

A battery pack enclosure of this disclosure will now be described with reference to FIG. 1, which is a schematic of a battery pack 100, according to embodiments of this disclosure. Battery pack 100 comprises battery pack enclosure 150. Battery pack enclosure 150 comprises (e.g., thermoplastic-intensive) cover 110 and thermoplastic-intensive structural cell holder (PISCH) 130, and is configured to enclose a plurality of cuboidal cells 120. According to embodiments of this disclosure, an apparatus 155 for housing battery cells 120 can comprise battery pack enclosure 150 and bottom impact protection system (BIPS) 140. Each of the components of battery pack 100 of FIG. 1 will be detailed further hereinbelow.

A battery pack enclosure 150 of this disclosure can comprise a lid or cover 110 (referred to hereinafter as a “cover 110”); and a plastic-intensive structural cell holder (PISCH) 130. As depicted in FIG. 2, which is a schematic of a PISCH 130 with cells 120 assembled and connected, according to embodiments of this disclosure, PISCH 130 is configured to hold a plurality of cuboidal battery cells 120. The battery pack enclosure 150 can be a thermoplastic-intensive battery pack enclosure 150 that comprises greater than or equal to about 30, 40, or 50 weight percent (wt %) thermoplastic. The thermoplastic of thermoplastic-intensive battery pack enclosure 150 can comprise polypropylene (PP), polybutyleneterephthalate (PBT), polyethylene terephthalate (PET), polycarbonate (PC), polyamide, polyimide, polyetherimide, a fire retardant polymer, or a combination thereof. The thermoplastic can comprise fire retardant polypropylene (PP), polybutyleneterephthalate (PBT), polyethyleneterephthalate (PET), polycarbonate (PC), polyamide, polyimide, polyetherimide, or like, or a combination thereof, wherein fire retardant is defined as having at least UL VO rating at 3 mm as per ASTM. In embodiments, the thermoplastic comprises STAMAX™ which is a long glass filled polypropylene composite, PPc which is a polypropylene (PP) compounded with short glass fiber or other additives, VALOX™ which is a semi-crystalline family of PBT, PET and blends with polycarbonate (PC), CYCOLOY™ which is a polycarbonate and acrylonitrile butadiene styrene (PC+ABS) blend, LEXAN™ which is a polycarbonate, XENOY™ which is a PC+PBT or PC+PET that is optionally reinforced by glass fiber, or a combination thereof.

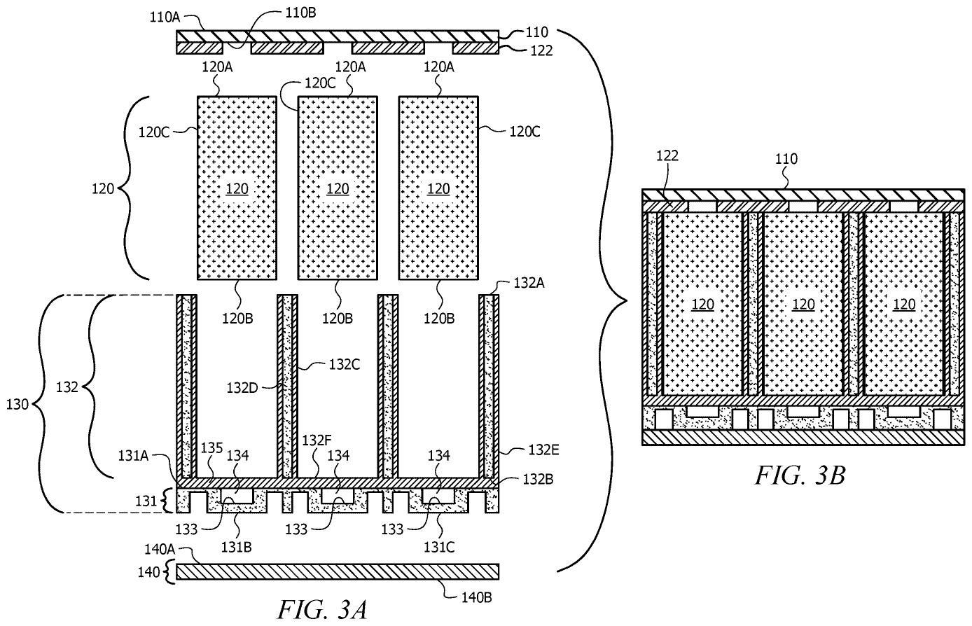

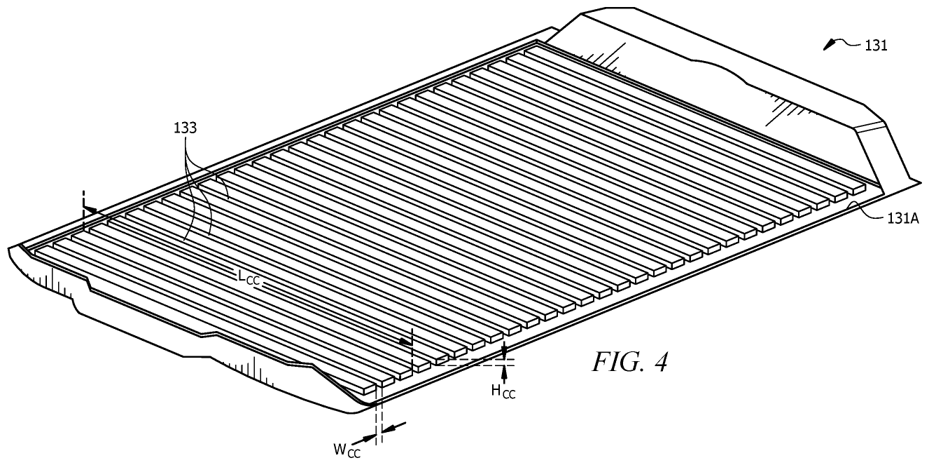

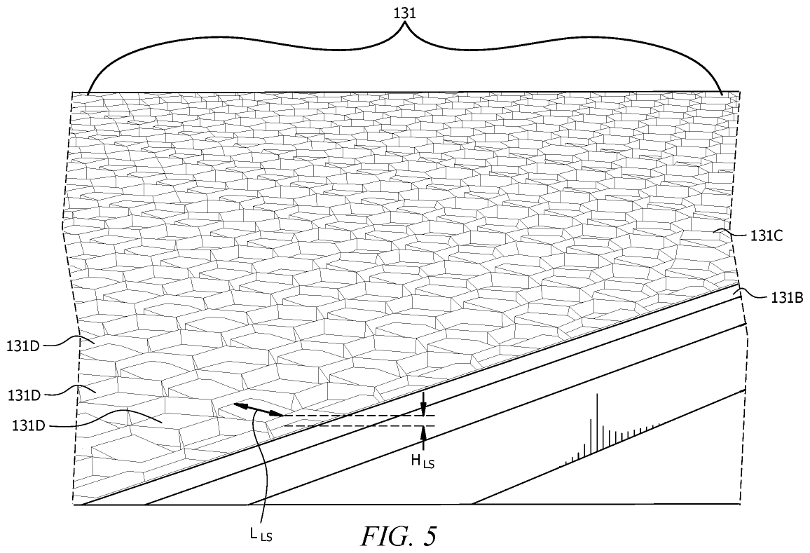

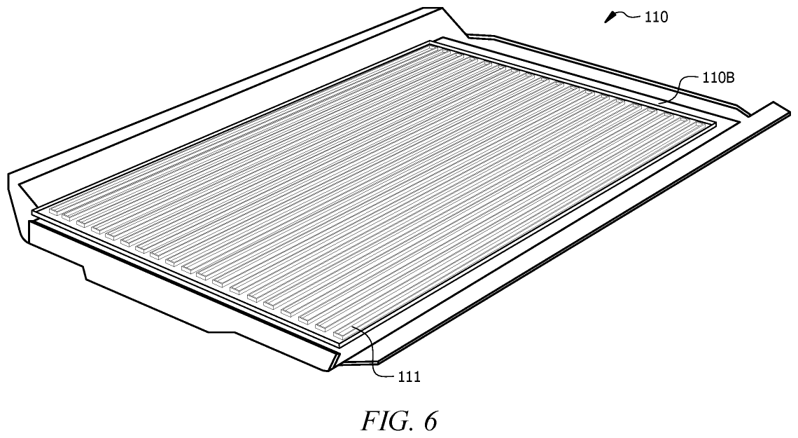

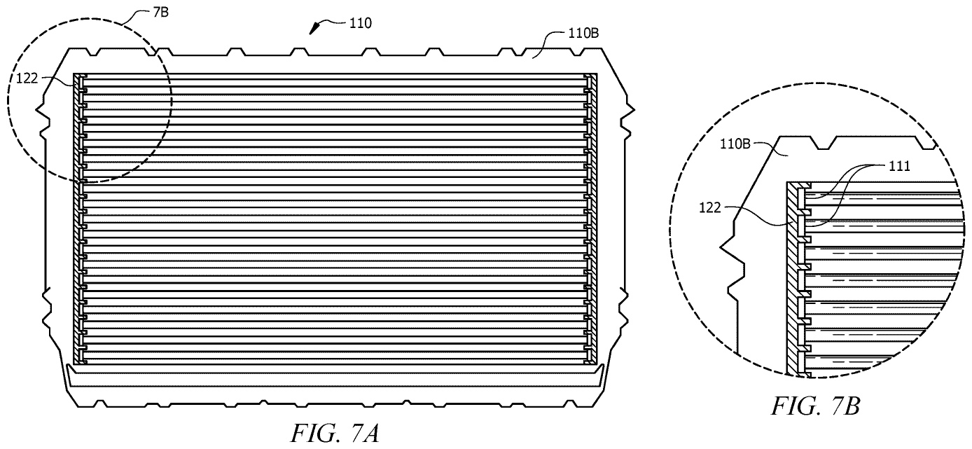

FIG. 3A is a schematic of a section of battery pack 100, in a disassembled configuration, according to embodiments of this disclosure, and FIG. 3B is a schematic of the section of the battery pack 100 of FIG. 3A, in an assembled configuration. With reference to FIG. 3A and FIG. 3B, PISCH 130 comprises a plastic tray 131 and a plurality of structural cell holders 132. The structural cell holders 132 are designed to accommodate the battery cells 120. Battery cells 120 can slip fit into cell holders 132 in a discharged state or optionally can snap fit into cell holders 132 with an appropriate locking mechanism on the cells 120 and cell holders 132. By way of non-limiting example, one such locking mechanism can be protrusion on the cell 120 walls that snap into flexible fairings on the receptacle walls of cell holders 132. Optionally, a thermal paste can be squeezed between the battery cells 120 and the cell holders 132 to ensure good thermal contact. The plurality of structural cell holders 132 extend vertically from a top side 131A of the plastic tray 131. The top side 131A of the plastic tray 131 is opposite a bottom side 131B thereof, and the plastic tray 131 comprises a plurality of coolant channels 133. Coolant channels 133 can be integrated into the top side 131A of the plastic tray 131 and are configured to contain coolant 134. Coolant 134 can comprise air, water and ethylene glycol mix, refrigerants, or a combination thereof. The plastic of the PISCH 130 can act as both a thermal barrier and as a structural support. Thermal management can be achieved with the structural plastic-intensive backbone, via coolant 134 in coolant channels 133 and separation of the battery cells 120 via the PISCH and cover 110, described below with reference to FIG. 6, FIG. 7A, and FIG. 7B.

A cavity defined by the structural cell holders of the PISCH and the cover in the closed configuration can be shaped to house each of the cuboidal battery cells. Each of the cuboidal battery cells can be disposed adjacent to or abut one or both the cover and the structural cell holder lattice. Thus each of the cuboidal battery cells can be a stressed member of the structural battery pack. There can be a small clearance between each of the cuboidal battery cells and the structural lattice, such as to provide for swelling in use. Nonetheless, in an impact the small clearance would be closed and the cuboidal battery cells would then serve as a stressed member. The cuboidal battery cells can serve as a stressed member of the structural battery pack while the PISCH is under load over a selected crash threshold. The selected crash threshold can be associated with an side impact or another impact.

The shape of cuboidal cells, versus e.g. cylinders, provides for superior performance as a stressed member. In another example, the structural lattice can be shape to accommodate a plurality of cylinders, hexagons, and the like, and in such cases the cells can serve as stressed members insofar as the lattice can maintain their alignment in an impact.

The PISCH 130 can comprise a thermoplastic-intensive PISCH 130 comprising greater than or equal to about 20, 30, 40, or 50 weight percent (wt %) thermoplastic. The thermoplastic of thermoplastic-intensive PISCH 130 can comprise polypropylene (PP), polybutyleneterephthalate (PBT), polyethylene terephthalate (PET), polycarbonate (PC), polyamide, polyimide, polyetherimide, a fire retardant polymer, or a combination thereof. The thermoplastic can comprise fire retardant polypropylene (PP), polybutyleneterephthalate (PBT), polyethyleneterephthalate (PET), polycarbonate (PC), polyamide, polyimide, polyetherimide, or like, or a combination thereof, wherein fire retardant is defined as having at least UL VO rating at 3 mm as per ASTM. In embodiments, the thermoplastic comprises STAMAX™ which is a long glass filled polypropylene composite, PPc which is a polypropylene (PP) compounded with short glass fiber or other additives, VALOX™ which is a semi-crystalline family of PBT, PET and blends with polycarbonate (PC), CYCOLOY™ which is a polycarbonate and acrylonitrile butadiene styrene (PC+ABS) blend, LEXAN™ which is a polycarbonate, XENOY™ which is a PC+PBT or PC+PET that is optionally reinforced by glass fiber, or a combination thereof.

With reference to FIG. 4, which is a schematic, top view of a plastic tray 131, according to embodiments of this disclosure, the height H_{CC} of the coolant channels 133 can be in a range of from about 1 to about 4 mm, from about 1 to about 5 mm, or from about 1 to about 8 mm, and the width W_{CC} of the coolant channels 133 can be in a range of from about 2 to about 10 mm, from about 2 to about 8 mm, or from about 1 to about 10 mm. The coolant channels 133 can extend a length L_{CC} substantially equal to 80, 90, or 95% of the width of plastic tray 131, in embodiments. The coolant channels 133 can be distributed laterally, for example, with a spacing of from about 2 to about 20 mm, from about 2 to about 15 mm, or from about 1 to about 10 mm, to achieve uniform heat removal from the battery cells 120. With reference to FIG. 2, the cuboidal battery cells 120 can have a width W_{BC} in a range of from about 1 to about 10 cm, from about 1 to about 8 cm, or from about 2 to about 10 cm, a depth D_{BC} in a range of from about 1 to about 10 cm, from about 1 to about 8 cm, or from about 2 to about 10 cm, and/or a height H_{BC} in a range of from about 5 to about 100 cm, from about 5 to about 50 cm, or from about 2 to about 100 cm.

Plastic tray 131 can further comprise a structural lattice 131C integrated into the bottom side 131B thereof. The length L_{LS} of the lattice structure (walls) can vary from about 0.5 to about 5 cm, from about 0.5 to about 4 cm, or from about 0.5 to about 3 cm. The sides of the polyhedral shapes for the lattice structure 131C can have a height H_{LS} in a range of from about 1 to 10 cm, of from about 1 to 8 cm, or of from about 1 to 5 cm, in embodiments.

In embodiments, the structural lattice 131C comprises a square or hexagonal or polygonal structural lattice having, respectively, lattice members 131D with a square or hexagonal or polygonal cross section. Other lattice structures 131C, with lattice members 131D having alternate cross sectional shapes, are within the scope of this disclosure.

The PISCH 130 can be an injection molded or compression molded PISCH 130. The PISCH 130 can further comprise a conductive plate or laminate 135 between the plastic tray 131 and bottoms 132B of the structural cell holders 132. The conductive plate or laminate 135 can be adjacent to and extend entirely atop the top side 131A of the plastic tray 131. The structural cell holders 132 can be positioned on the conductive plate or laminate 135.

In embodiments, the cuboidal cells 120 have outer surfaces (e.g., including side walls, top, and bottom) 120C. In embodiments, the outer surfaces 120C of the cuboidal cells 120 comprise metal, and the structural cell holders 132 are plastic structural cell holders 132 comprising plastic outer surfaces 132C. In alternative embodiments, the outer surfaces 120C of the cuboidal cells 120 comprise non-metal, and the structural cell holders 132 are hybrid metal-plastic structural cell holders 132 comprising metal outer surfaces 132C and plastic (or thermoplastic) interiors 132D.

With reference to FIG. 6, which is a schematic bottom view of a cover 110, according to embodiments of this disclosure, FIG. 7A, which is a schematic bottom view of the a cover 110, and FIG. 7B, which is a close up of a portion of the schematic bottom view of the cover of FIG. 7A, cover 110 is configured to cover tops 132A of the plurality of structural cell holders 132 when the PISCH 130 is in a closed configuration. In embodiments, cover 110 comprises a thermoplastic-intensive cover 110, wherein the thermoplastic-intensive cover 110 comprises greater than or equal to about 30, 40, or 50 weight percent (wt %) thermoplastic. The thermoplastic of thermoplastic-intensive cover 110 can comprise polypropylene (PP), polybutyleneterephthalate (PBT), polyethylene terephthalate (PET), polycarbonate (PC), polyamide, polyimide, polyetherimide, a fire retardant polymer, or a combination thereof.

In embodiments, the cover 110 and the PISCH 130 are configured to snap together in a closed configuration of the battery pack enclosure 150.

The cover 110 can comprise a bottom surface 110B configured to be parallel to and adjacent the tops 132A of the structural cell holders 132 when the battery pack enclosure 150 is in a closed configuration. The bottom surface 110B of the cover 110 can be configured as a thermal protection barrier comprising recesses 111 designed to cover busbar connections 122 and/or terminals 121 on the tops 120A of the cuboidal cells 120 that are configured to close an electrical circuit along the cuboidal cells 120 when the battery pack enclosure 150 is in a closed configuration. The bottom surface 110B of the cover 110 can comprise metal busbars or connectors 122 integrated therein, wherein the metal busbars or connectors 122 can be integrated into the bottom surface 110B of the cover 110 such that, in the closed configuration of the battery pack enclosure 150, the metal busbars or connectors 122 are in (e.g., snap into) contact with terminals 121 on the tops 120A of the cuboidal cells 120.

The protective channels or recesses 111 employed for the busbars or connectors 122, or a portion of the recesses 111 not employed for busbars or connectors 122, can also serve as flow guides for runaway gases. Alternatively or additionally, the battery pack enclosure 150 can further comprising ducts configured to enable flow of gas from within the battery pack enclosure 150.

Also disclosed herein is an apparatus 155 for housing battery cells 120, the apparatus 155 comprising: the battery pack enclosure 150 of this disclosure and a bottom impact protection system (BIPS) 140. The BIPS 140 can comprise a structural tray having a thickness selected to support the weight of the battery pack enclosure 150. The BIPS 140 can comprise a puncture resistant tray engineered to resist puncture normal to the width of the BIPS 140. The BIPS 140 can comprise a metal tray that extends along the entire bottom side 131B of the plastic tray 131. The BIPS 140 has a top surface 140A parallel to and adjacent the bottom side 131B of the plastic tray 131 when the apparatus is in an assembled configuration. The BIPS 140 is configured to protect the battery pack enclosure 150 from impact/intrusion of foreign objects. The BIPS 140 can be an energy absorber. The BIPS 140 can be engineered for non-linear deformation under impact. The BIPS 140 can be a non-linear deforming energy absorber. The BIPS 140 can include one or more features to accommodate non-linear deformation, such as honeycombs, slots positioned longitudinal to a selected lateral side impact direction, or other stress risers.

Also disclosed herein is a battery pack 100 comprising: the apparatus for housing battery cells 155 in an assembled configuration in which the battery pack enclosure 150 encloses the plurality of cuboidal cells 120. The battery pack 100 can have a cell to pack volumetric efficiency that is greater than or equal to about 50, 60, or 70%, wherein the cell to pack volumetric efficiency is defined as an overall volume of the battery pack 100 divided by a volume of all cuboidal cells 120 of the plurality of cuboidal cells 120. In embodiments, the cell to pack volumetric efficiency is greater (e.g., at least 10, 20, or 30% greater) than that of an otherwise similar battery pack comprising a plurality of non-cuboidal (e.g., cylindrical) cells, wherein the cell to pack volumetric efficiency is defined as an overall volume of the battery pack 100 divided by a volume of all cells of the plurality of cells. The battery pack 100 of this disclosure can have pack level volumetric energy density, defined as the energy per pack volume, of at least 325, 400, or 450 Wh/l (Watt-hours per liter). A number of cuboidal cells 120 in the battery pack 100 can have less than (e.g., 20, 50, or 90 percent less) a number of battery cells in an otherwise similar battery pack comprising non-cuboidal cells. The volumetric energy density of the battery pack 100 can be at least 10, 20, or 30% greater than a volumetric energy density of the otherwise-similar battery pack.

The cuboidal cells 120 can be battery cells as described in WO 2022/008748, WO 2022/008745, WO 2022/136094, WO 2022/008743 or WO 2021/069115, the disclosure of each of which is hereby incorporated herein in its entirety for purposes not contrary to this disclosure. For example, in embodiments, each cuboidal cell 120 of the plurality of cuboidal cells 120 can comprise a battery cell as described in WO 2022/008748, comprising: a container comprising one or more walls that define a cavity; a plurality of power units disposed within the cavity, each power unit comprising: a first electrode; a second electrode; and a separator disposed between the first and second electrode; and a first conductive member coupled to at least one of the first electrodes of the plurality of power units, the first conductive member disposed within the cavity between the first electrodes and at least one of the one or more walls and configured to distribute heat and/or current from the at least one first electrode. In alternative embodiments, each cuboidal cell 120 of the plurality of cuboidal cells 120 can comprise a battery cell as described in WO 2022/008745, comprising: comprises: a first power unit comprising: a first electrode including a first current collector coupled to a first conductive member; and a second electrode; and a separator comprising: a first portion interposed between the first electrode and the second electrode; and a second portion positioned between the second electrode and the first conductive member; and wherein the second portion of the separator is configured to break responsive to receipt of a force to the battery.

In embodiments, the plurality of cuboidal cells 120 snap into the battery pack enclosure 150. An intrusion, as measured during a rigid side crash at 32 km/h to the battery pack, can be reduced by at least 5, 10, or 20 mm, relative to an intrusion measured on an otherwise-similar battery pack comprising non-cuboidal cells.

Herein disclosed is a novel thermoplastic battery enclosure 150 with a plastic-intensive structural back bone designed to package cuboidal cells 120. The thermoplastic hybrid system serves as a structural back bone to host the battery cells 120, and also serves as an effective thermal management system to control the temperature of the cuboidal cells 120 by effectively transferring heat to the battery cells 120 or from the battery cells 120 as needed. A plastic tray 131 provides both integrated cooling channels 133 on a top side 131A thereof and an integrated structural honeycomb rib configuration or lattice structure 131C on a bottom side 131B thereof. A thermoplastic intensive lid/cover 110 serves to close the battery enclosure assembly 150, and provides integrated thermal barrier protection covering the busbar connections 122 utilized to complete the electrical circuit between various battery cells 120. The hybrid thermoplastic battery pack enclosure 150 can be produced via common manufacturing methods, such as injection molding and or compression molding.

Other advantages will be apparent to those of skill in the art and with the help of this disclosure.

### EXAMPLE

The embodiments having been generally described, the following example is given as a particular example to demonstrate the practice and advantages of this disclosure. It is understood that the example is given by way of illustration and is not intended to limit the specification or the claims in any manner.

### Example: Side Impact Testing

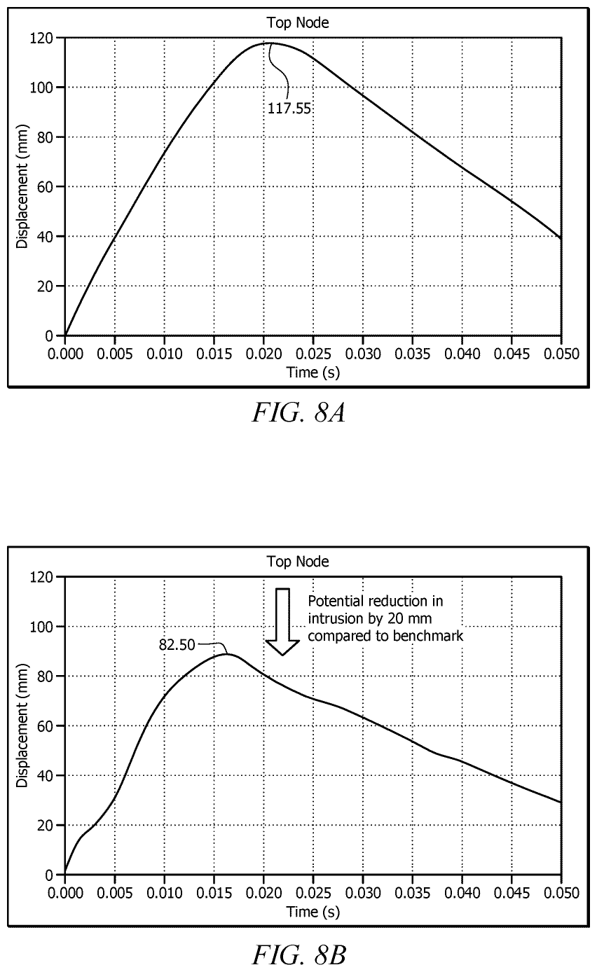

The herein disclosed battery pack enclosure 150 was investigated for its structural performance against a benchmarked cylindrical battery pack. In order to demonstrate this side impact performance, one of the most common and stringent performance requirements, simulations were performed on both the conventional cylindrical cell battery pack and the herein disclosed battery pack 100 comprising cuboidal cells 120. The results are shown in FIG. 8A and FIG. 8B, respectively. As demonstrated in FIG. 8A and FIG. 8B, the inventive battery pack 100 of FIG. 8B provides for better performance by reducing the intrusion, and thereby offering a better crash performance.

A battery pack enclosure 150 can comprise a cover 110 and a plastic-intensive structural cell holder (PISCH) 130 configured to hold a plurality of cuboidal battery cells 120, wherein the PISCH 130 comprises a plastic tray 131 and a plurality of structural cell holders 132. The plurality of structural cell holders 132 can extend vertically from a top side 131A of the plastic tray 131. The top side 131A of the plastic tray 131 can be opposite a bottom side 131B thereof. The plastic tray 131 can comprise a plurality of coolant channels 133 integrated into the top side 131A of the plastic tray 131 and configured to contain coolant 134. The cover 110 can be configured to cover tops 132A of the plurality of structural cell holders 132 when the PISCH 130 is in a closed configuration. The plastic of the PISCH 130 can act as a thermal barrier and as a structural support.

A cavity defined by the structural cell holders of the PISCH and the cover in the closed configuration can be shaped to house each of the cuboidal battery cells. Each of the cuboidal battery cells can abut one or both the cover and the structural cell holder lattice. Thus each of the cuboidal battery cells can be a stressed member of the structural battery pack. There can be a small clearance between each of the cuboidal battery cells and the structural lattice, such as to provide for swelling in use. Nonetheless, in an impact the small clearance would be closed and the cuboidal battery cells would then serve as a stressed member. The shape of cuboidal cells, versus e.g. cylinders, provides for superior performance as a stressed member. In another example, the structural lattice can be shape to accommodate a plurality of cylinders, hexagons, and the like, and in such cases the cells can serve as stressed members insofar as the lattice can maintain their alignment in an impact.

The battery pack enclosure 150 can comprise a structural lattice 131C integrated into the bottom side 131B thereof. The battery pack enclosure 150 can comprise a square or hexagonal structural lattice having, respectively, lattice members 131D with a square or hexagonal cross section. The cuboidal cells 120 can have outer surfaces (e.g., including walls, top, and bottom) 120C. The outer surfaces 120C of the cuboidal cells 120 can comprise metal. The structural cell holders 132 can be plastic structural cell holders 132 comprising plastic outer surfaces 132C. The outer surfaces 120C of the cuboidal cells 120 can comprise non-metal. The structural cell holders 132 can be can be hybrid metal-plastic structural cell holders 132 comprising metal outer surfaces 132C and plastic (or thermoplastic) interiors 132D. The cover 110 can comprise a thermoplastic-intensive cover 110, wherein the thermoplastic-intensive cover 110 can comprise greater than or equal to about 30, 40, or 50 weight percent (wt %) thermoplastic. The thermoplastic can comprise polypropylene (PP), polybutyleneterephthalate (PBT), polyethylene terephthalate (PET), polycarbonate (PC), polyamide, polyimide, polyetherimide, a fire retardant polymer, or a combination thereof. The PISCH 130 can comprise greater than or equal to about 20, 30, 40, or 50 weight percent (wt %) thermoplastic. The thermoplastic can comprise fire retardant polypropylene (PP), polybutylene terephthalate (PBT), polyethylene terephthalate (PET), polycarbonate (PC), polyamide, polyimide, polyetherimide, or like, or a combination thereof, wherein fire retardant can be defined as having at least UL VO rating at 3 mm as per ASTM. The thermoplastic can comprise STAMAX™ which can be a long glass filled polypropylene composite, PPc which can be a polypropylene compounded with short glass fiber or other additives, VALOX™ which can be a semi-crystalline family of PBT, PET and blends with polycarbonate (PC), CYCOLOY™ which can be a polycarbonate and acrylonitrile butadiene styrene (PC+ABS) blend, LEXAN™ which can be a polycarbonate, XENOY™ which can be a PC+PBT or PC+PET that can be optionally reinforced by glass fiber, or a combination thereof.

The cover 110 and the PISCH 130 can be can snap together in a closed configuration of the battery pack enclosure 150. The cover 110 can comprise a bottom surface 110B configured to be parallel to and adjacent the tops 132A of the structural cell holders 132 when the battery pack enclosure 150 can be in a closed configuration.

The bottom surface 110B of the cover 110 can be configured as a thermal protection barrier comprising recesses 111 designed to cover busbar connections 122 and/or terminals 121 on the tops 120A of the cuboidal cells 120 that can be configured to close an electrical circuit along the cuboidal cells 120 when the battery pack enclosure 150 can be in a closed configuration. The bottom surface 110B of the cover 110 can comprise metal busbars or connectors 122 integrated therein, wherein the metal busbars or connectors 122 can be integrated into the bottom surface 110B of the cover 110 such that, in the closed configuration of the battery pack enclosure 150, the metal busbars or connectors 122 can be in (e.g., snap into) contact with terminals 121 on the tops 120A of the cuboidal cells 120.

The PISCH 130 can be an injection molded or compression molded PISCH 130. The PISCH 130 further can comprise a conductive plate or laminate 135 between the plastic tray 131 and bottoms 132B of the structural cell holders 132, wherein the conductive plate or laminate 135 can be adjacent to and extends entirely atop the top side 131A of the plastic tray 131, and wherein the structural cell holders 132 can be positioned on the conductive plate or laminate 135. Ducts can enable discharge of gas from within the battery pack enclosure 150.

The battery pack enclosure 150 can include a bottom impact protection system (BIPS) 140. The BIPS 140 can comprise a metal tray that extends along the entire bottom side 131B of the plastic tray 131, wherein the BIPS 140 has a top surface 140A parallel to and adjacent the bottom side 131B of the plastic tray 131 when the apparatus can be in an assembled configuration, and wherein the BIPS 140 can be configured to protect the battery pack enclosure 150 from impact/intrusion of foreign objects.

The battery pack 100 can enclose the plurality of cuboidal cells 120, wherein the battery pack 100 has a cell to pack volumetric efficiency that can be greater than or equal to about 50, 60, or 70%, wherein the cell to pack volumetric efficiency can be defined as an overall volume of the battery pack 100 divided by a volume of all the cuboidal cells 120 of the plurality of cuboidal cells 120. The cell to pack volumetric efficiency can be greater (e.g., at least 10, 20, or 30% greater) than that of an otherwise similar battery pack comprising a plurality of non-cuboidal (e.g., cylindrical) cells, wherein the cell to pack volumetric efficiency can be defined as an overall volume of the battery pack 100 divided by a volume of all the cells 120 of the plurality of cells 120. The pack level volumetric energy density, defined as the energy per pack volume of at least 325, 400, or 450 Wh/l. and/or wherein a number of cuboidal cells 120 in the battery pack 100 can be less than (e.g., 20, 50, or 90 percent less) a number of battery cells in an otherwise similar battery pack comprising non-cuboidal cells. The volumetric energy density of the battery pack 100 can be at least 10, 20, or 30% greater than a volumetric energy density of the otherwise-similar battery pack.

The battery pack 100 of any one of the nineteenth to twenty third embodiments, wherein each cuboidal cell 120 of the plurality of cuboidal cells 120 can comprise a container comprising one or more walls that define a cavity, a plurality of power units disposed within the cavity, each power unit comprising: a first electrode, a second electrode, and a separator disposed between the first and second electrode, and a first conductive member coupled to at least one of the first electrodes of the plurality of power units, the first conductive member disposed within the cavity between the first electrodes and at least one of the one or more walls and configured to distribute heat and/or current from the at least one first electrode.

The battery pack 100 of any one of the nineteenth to twenty fourth embodiments, wherein each cuboidal cell 120 of the plurality of cuboidal cells 120 comprises: a first power unit comprising a first electrode including a first current collector coupled to a first conductive member, and a second electrode, and a separator comprising a first portion interposed between the first electrode and the second electrode, and a second portion positioned between the second electrode and the first conductive member, wherein the second portion of the separator can be configured to break responsive to receipt of a force to the battery.

The battery pack 100 of any one of the nineteenth to twenty fifth embodiments, wherein the plurality of cuboidal cells 120 snap into the battery pack enclosure 150.

The battery pack 100 of any one of the nineteenth to twenty sixth embodiments, wherein an intrusion, as measured during a rigid side crash at 32 km/h to the battery pack, can be reduced by at least 10, 15, or 20 mm (and/or 5, 10, or 20%), relative to an intrusion measured on an otherwise-similar battery pack comprising non-cuboidal cells.

While embodiments have been shown and described, modifications thereof can be made by one skilled in the art without departing from the spirit and teachings of this disclosure. The embodiments described herein are exemplary only, and are not intended to be limiting. Many variations and modifications of the embodiments disclosed herein are possible and are within the scope of this disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, RI, and an upper limit, Ru, is disclosed, any number falling within the range is specifically disclosed. In particular, the following numbers within the range are specifically disclosed: R=Rl+k*(Ru−Rl), wherein k is a variable ranging from 1 percent to 100 percent with a 1 percent increment, i.e., k is 1 percent, 2 percent, 3 percent, 4 percent, 5 percent, . . . 50 percent, 51 percent, 52 percent, . . . , 95 percent, 96 percent, 97 percent, 98 percent, 99 percent, or 100 percent. Moreover, any numerical range defined by two R numbers as defined in the above is also specifically disclosed. Use of broader terms such as comprises, includes, having, etc. should be understood to provide support for narrower terms such as consisting of, consisting essentially of, comprised substantially of, etc. When a feature is described as “optional,” both embodiments with this feature and embodiments without this feature are disclosed. Similarly, the present disclosure contemplates embodiments where this “optional” feature is required and embodiments where this feature is specifically excluded.

Accordingly, the scope of protection is not limited by the description set out above but is only limited by the claims which follow, that scope including all equivalents of the subject matter of the claims. Each and every claim is incorporated into the specification as embodiments of the present disclosure. Thus, the claims are a further description and are an addition to the embodiments of the present disclosure. The discussion of a reference herein is not an admission that it is prior art, especially any reference that can have a publication date after the priority date of this application. The disclosures of all patents, patent applications, and publications cited herein are hereby incorporated by reference, to the extent that they provide exemplary, procedural, or other details supplementary to those set forth herein.

1. A structural battery pack enclosure comprising:
a cover; and
a plastic-intensive structural cell holder (PISCH) shaped to hold a plurality of cuboidal battery cells, wherein the PISCH comprises a plastic tray and a plurality of structural cell holders, wherein the plurality of structural cell holders extend vertically from a top side of the plastic tray to define a cell holder structural lattice, wherein the top side of the plastic tray is opposite a bottom side of the plastic tray, and wherein the plastic tray comprises a plurality of coolant channels formed into the bottom side of the plastic tray,
wherein the cover is shaped to cover tops of the plurality of structural cell holders when the PISCH is in a closed configuration, and
wherein a cavity defined by the structural cell holders of the PISCH and the cover in the closed configuration is shaped to house each of the cuboidal battery cells, with each of the cuboidal battery cells disposed adjacent both the cover and the structural cell holder lattice such that each of the cuboidal battery cells is a stressed member of the structural battery pack while the PISCH is under load over a selected crash threshold.

2. The structural battery pack enclosure of claim 1, wherein the plastic tray further comprises an energy absorber comprising a structural lattice formed on the bottom side thereof, optionally wherein the structural lattice comprises a square or hexagonal structural lattice having, respectively, lattice members with a square or hexagonal cross section.

3. The structural battery pack enclosure of claim 1, wherein the cuboidal cells have outer surfaces and:
wherein the outer surfaces of the cuboidal cells comprise metal, and wherein the structural cell holders are plastic structural cell holders comprising plastic outer surfaces;
or
wherein outer surfaces of the cuboidal cells comprise non-metal, and wherein the structural cell holders are hybrid metal-plastic structural cell holders comprising metal outer surfaces and plastic or thermoplastic interiors.

4. The structural battery pack enclosure of claim 1, wherein the cover comprises a thermoplastic-intensive cover, wherein the thermoplastic-intensive cover comprises greater than or equal to about 30 weight percent (wt %) thermoplastic;
and/or
wherein the PISCH comprises greater than or equal to about 20 weight percent (wt %) thermoplastic, optionally wherein the thermoplastic comprises fire retardant polypropylene, polybutyleneterephthalate, polycarbonate, polyamide, polyimide, polyetherimide, or like, or a combination thereof, wherein fire retardant is defined as having at least UL VO rating at 3 mm as per ASTM.

5. The structural battery pack enclosure of claim 1, wherein the cover comprises a bottom surface configured to be parallel to and adjacent the tops of the structural cell holders when the structural battery pack enclosure is in a closed configuration.

6. The structural battery pack enclosure of claim 5, wherein the bottom surface of the cover is configured as a thermal protection barrier comprising recesses designed to cover busbar connections and/or terminals on the tops of the cuboidal cells that are configured to close an electrical circuit along the cuboidal cells when the structural battery pack enclosure is in a closed configuration.

7. The structural battery pack enclosure of claim 5, wherein the bottom surface of the cover comprises metal busbars or connectors integrated therein, wherein the metal busbars or connectors are integrated into the bottom surface of the cover such that, in the closed configuration of the structural battery pack enclosure, the metal busbars or connectors are in contact with terminals on the tops of the cuboidal cells.

8. The structural battery pack enclosure of claim 1, wherein the PISCH further comprises a conductive plate or laminate between the plastic tray and bottoms of the structural cell holders, wherein the conductive plate or laminate is adjacent to and extends entirely atop the top side of the plastic tray, and wherein the structural cell holders are positioned on the conductive plate or laminate.

9. An apparatus for housing battery cells, the apparatus comprising:
a structural battery pack enclosure comprising:
a cover; and
a plastic-intensive structural cell holder (PISCH) configured to hold a plurality of cuboidal battery cells, wherein the PISCH comprises a plastic tray and a plurality of structural cell holders, wherein the plurality of structural cell holders extend vertically from a top side of the plastic tray, wherein the top side of the plastic tray is opposite a bottom side thereof, and wherein the plastic tray comprises a plurality of coolant channels integrated into the top side of the plastic tray and configured to contain coolant,
wherein the cover is configured to cover tops of the plurality of structural cell holders when the PISCH is in a closed configuration; and
a bottom impact protection system (BIPS) comprising a tray,
wherein a cavity defined by the structural cell holders of the PISCH and the cover in the closed configuration is shaped to house each of the cuboidal battery cells, with each of the cuboidal battery cells disposed adjacent both the cover and the structural cell holder lattice such that each of the cuboidal battery cells is a stressed member of the structural battery pack.

10. The apparatus of claim 9, wherein the BIPS comprises a metal tray that extends along the entire bottom side of the plastic tray, wherein the BIPS has a top surface parallel to and adjacent the bottom side of the plastic tray when the apparatus is in an assembled configuration, and wherein the BIPS is configured to protect the structural battery pack enclosure from impact/intrusion of foreign objects.

11. The apparatus of claim 9, comprising greater than or equal to about 20 weight percent (wt %) thermoplastic.

12. A structural battery pack comprising:
an apparatus for housing a plurality of cuboidal battery cells, the apparatus comprising:
a structural battery pack enclosure comprising:
a cover; and
a plastic-intensive structural cell holder (PISCH) configured to hold a plurality of cuboidal battery cells, wherein the PISCH comprises a plastic tray and a plurality of structural cell holders, wherein the plurality of structural cell holders extend vertically from a top side of the plastic tray, wherein the top side of the plastic tray is opposite a bottom side thereof, and wherein the plastic tray comprises a plurality of coolant channels integrated into the top side of the plastic tray and configured to contain coolant,
wherein the cover is configured to cover tops of the plurality of structural cell holders when the PISCH is in a closed configuration; and
a bottom impact protection system (BIPS),
wherein the structural battery pack enclosure encloses the plurality of cuboidal cells, and
wherein a cavity defined by the structural cell holders of the PISCH and the cover in the closed configuration is shaped to house each of the cuboidal battery cells, with each of the cuboidal battery cells disposed adjacent both the cover and the structural cell holder lattice such that each of the cuboidal battery cells is a stressed member of the structural battery pack.

13. The structural battery pack of claim 12, wherein the structural battery pack has a cell to pack volumetric efficiency that is greater than or equal to about 50%, wherein the cell to pack volumetric efficiency is defined as an overall volume of the structural battery pack divided by a volume of all the cuboidal cells of the plurality of cuboidal cells.

14. The structural battery pack of claim 13, wherein the cell to pack volumetric efficiency is greater than that of an otherwise similar battery pack comprising a plurality of non-cuboidal cells, wherein the cell to pack volumetric efficiency is defined as an overall volume of the structural battery pack divided by a volume of all the cells of the plurality of cells.

15. The structural battery pack of claim 12, wherein
the structural battery pack has pack level volumetric energy density, defined as the energy per pack volume, of at least 325 Wh/l;
wherein a number of cuboidal cells in the structural battery pack is less than a number of battery cells in an otherwise similar battery pack comprising non-cuboidal cells;
and/or
wherein the volumetric energy density of the structural battery pack is at least 10% greater than a volumetric energy density of the otherwise-similar battery pack.
